(19) United States
(12) Patent Application Publication
(10) Pub. No.: US 2024/0066793 A1
(43) Pub. Date: Feb. 29, 2024

(54) LARGE-SCALE CONTINUOUS FIBER ADDITIVE MANUFACTURED-COMPRESSION MOLDED COMPOSITE

(71) Applicant: UT-Battelle, LLC, Oak Ridge, TN (US)

(72) Inventors: Vipin Kumar, Oak Ridge, TN (US); Ahmed A. Hassen, Oak Ridge, TN (US); Vlastimil Kunc, Oak Ridge, TN (US); Cole Nielsen, Oak Ridge, TN (US); David Nuttall, Oak Ridge, TN (US)

(21) Appl. No.: 18/237,176

(22) Filed: Aug. 23, 2023

Related U.S. Application Data
(60) Provisional application No. 63/400,126, filed on Aug. 23, 2022.

(51) Int. Cl. B29C 64/165; B29C 43/02; B29C 64/209; B29C 64/30; B33Y 10/00; B33Y 30/00; B33Y 40/20

(52) U.S. Cl. CPC B29C 64/165; B29C 43/02; B29C 64/209; B29C 64/30; B33Y 10/00; B33Y 30/00; B33Y 40/20; B29K 2307/04

(57) ABSTRACT

A method of manufacturing an article is provided. The method includes feeding a polymeric material into an extruder including a nozzle, and feeding a continuous fiber into the extruder, the continuous fiber and the polymeric material together forming a molding compound. A three-dimensional preform is formed by discharging the molding compound from the nozzle onto a deposition surface. A mold charge is formed by positioning the three-dimensional preform within a mold that includes a top mold component and a bottom mold component. The mold charge is compression molded within the mold to form a finished article.

### CROSS-REFERENCE TO RELATED APPLICATIONS

This application claims the benefit of U.S. Provisional Application 63/400,126, filed Aug. 23, 2022, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to an improved method of manufacturing an article by compression molding a composite preform including continuous fibers.

### BACKGROUND OF THE INVENTION

Additive manufacturing (AM), commonly known as 3D printing, is a technique in which a part is modeled using computer-aided design (CAD) software or other methods, and further converted using another software called a “slicer” to transform the CAD model into a layer-wise representation of the model. The slicer file is then loaded into so-called “3D printers,” which produce the part layer-by-layer based on the slicer file. Additive manufacturing of polymer composites has made advancements in terms of materials that can be used and the process itself. Although additive manufacturing has proven to be a fantastic tool for prototyping of parts, replacing traditional part manufacturing processes with additive manufacturing still presents significant challenges. The main hurdle is the low mechanical properties of 3D-printed parts due to the presence of high porosity of pellet-based printed composites typically utilized by large-scale 3D printers and poor bead-to-bead interface.

To form structurally robust composite parts, reinforcements in the form of short fibers (such as carbon or glass fibers) can be used to impart mechanical properties to the parts. Multi-dimensional articles can be made of a preform having internal fibers arranged in one, two, or three dimensions. Traditionally, in continuous reinforced composites the fibers are fixed in a desired orientation at a predictable fiber volume according to one of a number of methods. For example, continuous fibers can be woven, stitched, or knitted, while discontinuous chopped fibers can be sprayed with a random orientation. These dry fiber forms are subsequently impregnated with a resin in a closed mold process, such as resin transfer molding (RTM) or vacuum assisted transfer molding (VARTM). The composite can then be used to achieve a net-shaped part with improved properties over metal parts.

However, existing methods for forming discontinuous reinforcement composites lack control of the microstructure of the composite constituents, which plays a critical role in determining the mechanical and thermal properties of the finished article. Further, in discontinuous fiber reinforced composites, a minimum fiber length is necessary to obtain optimal performance; however, during extrusion a significant amount of fiber length attrition occurs. Consequently, there is a continued need for an improved method for the production of complex parts with a carefully tailored microstructure for achieving the desired mechanical properties. Also, there remains a continued need for advanced methods of forming structurally robust preforms that can be used for the production of parts having the desired mechanical properties.

### SUMMARY OF THE INVENTION

A method of manufacturing an article is provided. The method includes feeding a polymeric material into an extruder including a nozzle, and feeding a continuous fiber into the extruder, the continuous fiber and the polymeric material together forming a molding compound. A three-dimensional preform is formed by discharging the molding compound from the nozzle onto a deposition surface. The molding compound can be deposited in a predetermined pattern, and this deposition can be performed in a single layer or in multiple layers. A mold charge is formed by positioning the three-dimensional preform within a mold that includes a top mold component and a bottom mold component. The mold charge is compression molded within the mold to form a finished article.

In specific embodiments, the nozzle of the extruder includes a single central channel configured to discharge the continuous fiber with the polymeric material such that the continuous fiber is comingled with the polymeric material. In other embodiments, the nozzle of the extruder includes coaxially aligned channels.

In certain embodiments, a volume fraction of the continuous fiber in the polymeric material is greater than 0% and less than or equal to 60%.

In specific embodiments, the continuous fiber is one of a carbon fiber, a glass fiber, a basalt fiber, and a Kevlar fiber.

In specific embodiments, the continuous fiber is arranged unidirectionally in the preform.

In specific embodiments, the polymeric material is one of a thermoplastic and a thermoset.

In certain embodiments, the polymeric material includes at least one of a nylon material, polyetheretherketone (PEEK), polyaryletherketone (PAEK), polyetherketone (PEK), polyetherketoneketone (PEKK), acrylonitrile butadiene styrene (ABS), polycarbonate (PC), polyphenylene sulfide (PPS), polyethylenimine (PEI), and polypropylene (PP).

In specific embodiments, the extruder is a coaxial extruder including coaxial channels, the polymeric material includes a first polymeric material and a second polymeric material, the continuous fiber includes a first continuous fiber and a second continuous fiber, and the steps of feeding a polymeric material and feeding a continuous fiber into the extruder include: feeding the first polymeric material into the extruder; feeding the first continuous fiber into the extruder, the first continuous fiber together with the first polymeric material forming a first molding compound; feeding the second polymeric material into the extruder, the second polymeric material being different than the first polymeric material; feeding the second continuous fiber into the extruder, the second continuous fiber being different than the first continuous fiber, and the second continuous fiber together with the second polymeric material forming a second molding compound; and the step of forming a three-dimensional preform includes discharging both the first molding compound and the second molding compound together onto the deposition surface.

A compression molded article formed by the method is also provided.

In other embodiments, a method of forming an additively manufactured preform for compression molding of an article is provided. The method includes feeding a polymeric material into an extruder including a nozzle. The method further includes feeding a continuous fiber into the extruder, the continuous fiber and the polymeric material together forming a molding compound. The method further includes forming a three-dimensional preform by discharging the molding compound from the nozzle onto a deposition surface.

In specific embodiments, the continuous fiber is embedded in the polymeric material, and the continuous fiber and polymeric material are simultaneously discharged together from a same nozzle of the extruder.

In specific embodiments, the extruder is a coaxial extruder including a nozzle having a first opening coaxially aligned with a larger second opening, the continuous fiber is discharged through the first opening, and the polymeric material is discharged through the second opening so as to surround the continuous fiber upon exit from the nozzle.

These and other features and advantages of the present invention will become apparent from the following description of the invention, when viewed in accordance with the accompanying drawings and appended claims.

### BRIEF DESCRIPTION OF THE DRAWINGS

FIG. 1 is a schematic view of a system for manufacturing an article by compression molding an additively manufactured preform in accordance with embodiments of the disclosure;

FIG. 2 is an illustration of a preform in accordance with embodiments of the disclosure;

FIG. 3 is a perspective view of a coaxial extruder in accordance with some embodiments of the system;

FIG. 4 is a pictorial view of preforms formed in accordance with embodiments of the disclosure;

FIG. 5 is a graph of flexural strength of continuous carbon fiber, continuous glass fiber, and hybrid continuous carbon fiber-glass fiber articles formed in accordance with embodiments of the disclosure;

FIG. 6 is a graph of flexural modulus of the continuous carbon fiber, continuous glass fiber, and hybrid continuous carbon fiber-glass fiber articles; and

FIG. 7 is a graph of tensile modulus of the continuous carbon fiber, continuous glass fiber, and hybrid continuous carbon fiber-glass fiber articles.

### DETAILED DESCRIPTION OF THE CURRENT EMBODIMENTS

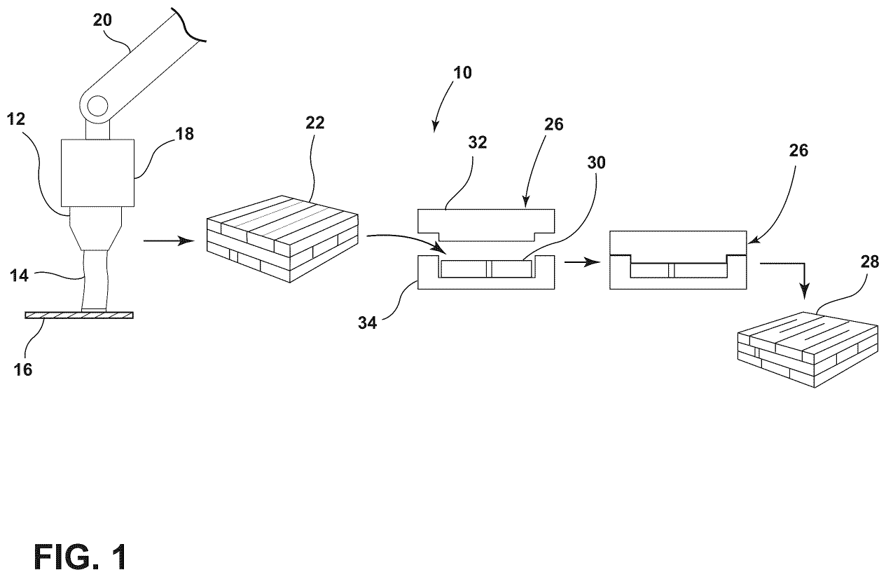

As discussed herein, a method according to embodiments of the disclosure includes the rapid manufacturing of a compression molded article with a preform formed by additive manufacturing and having continuous fibers. The combined additive manufacturing and compression molding process overcomes many shortcomings of existing additive manufacturing and subtractive (e.g., conventional molding) processes while retaining their desirable features. Additive manufacturing (AM) provides the benefit of less material waste, advanced geometries, and significantly reduced lead times, but parts formed by AM may have high porosity, poor bead-to-bead interface, slow cycle times and/or rough surface quality. Traditional subtractive processes such as compression molding (CM) provide high-quality surface finishes, low porosity, and good interface, but result in material waste and are limited in choice of materials and hence final properties and performance of the resulting parts. The method disclosed herein overcomes these and other drawbacks by performing an additive manufacturing step to form a preform followed by a compression molding step using the preform to obtain a part that has low porosity, good interface, complex designs, multi-material composition and hence optimized properties with minimum waste and fast cycle times. The method is described below in connection with the system of FIG. 1 and generally includes forming a preform by discharging a molding compound including a continuous fiber onto a deposition surface, forming a mold charge by positioning the preform within a mold, and compression molding the preform within the mold to form a finished article. These and other steps of the method are described in detail below.

In order to produce the preform, the method 10 first includes feeding a polymeric material and a continuous fiber into an extruder 12. The polymeric material can be any polymer material suitable for extrusion and additive manufacturing, may be a thermoplastic or thermoset, and may be, for example, selected from one or more of a nylon material (e.g., nylon 6 (PA6), nylon 12 (PA12)), polyetheretherketone (PEEK), polyaryletherketone (PAEK), polyetherketone (PEK), polyetherketoneketone (PEKK), acrylonitrile butadiene styrene (ABS), polycarbonate (PC), polyphenylene sulfide (PPS), polyethylenimine (PEI), and polypropylene (PP). The polymeric material includes a viscosity that is low enough to allow flow through a nozzle orifice, and includes a high enough zero shear viscosity to retain the desired shape of the deposited charge. The continuous fiber may be formed of one or more of a carbon fiber (e.g. a 12K carbon fiber, by way of example Mitsubishi T700 Continuous Carbon Fiber), a glass fiber (e.g. S-2 glass fiber such as a 12K S-2 fiber), a basalt fiber, and a Kevlar fiber. A continuous fiber as disclosed herein is a single continuous string of fiber material or wire material, as opposed to discontinuous fibers in which each fiber has a short length (e.g., more or less than 0.25 inches) and in which typically a multiplicity of fibers are included rather than a single string or wire. The continuous fiber together with the polymeric material form a molding compound 14 in which the continuous fiber becomes embedded in and/or sheathed by the polymeric material when extruded from the extruder such that the continuous fiber forms a core that is surrounded by the polymeric material. In yet other embodiments, discontinuous fibers may also be added to the molding compound such that the molding compounds includes both continuous fibers and discontinuous fibers to enhance localized performance of a preform formed by the molding compound. The discontinuous fibers may include, for example, melt extruded pellets (short fibers) or pultruded pellets (long fibers) formed of glass or graphite. The discontinuous fibers may have an aspect ratio of between 1:30 and 1:500, inclusive. Other discontinuous fiber materials include long-fiber-thermoplastics (LFT), typically 0.25 inches in length or greater, and short-fiber-plastics (SFT), typically less than 0.25 inches. In yet other embodiments, the discontinuous fibers may include spheres, granules, and flakes.

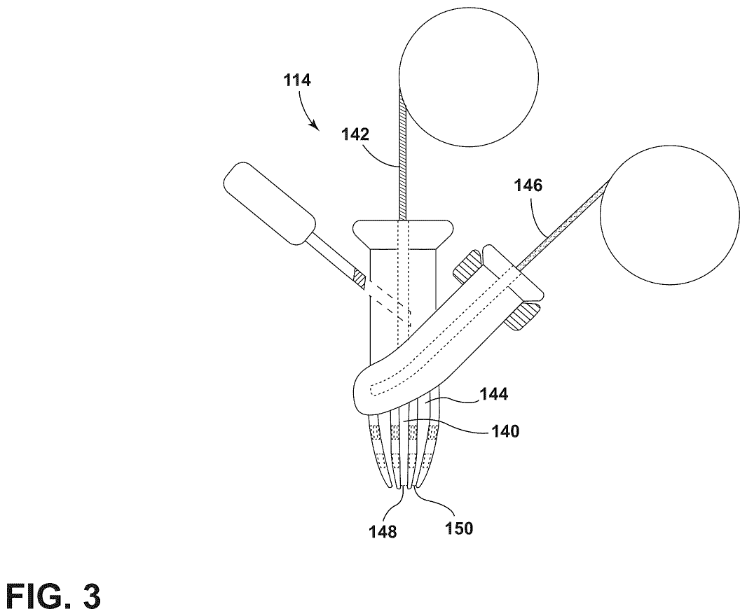

The extruder 14 has a nozzle from which the molding compound is discharged. The nozzle may have a single central channel via which the continuous fiber and polymeric material of the molding compound are together discharged from the single central channel via an orifice/opening. The volume fraction of the continuous fiber in the polymeric material may be greater than 0% and less than or equal to 60%, in other words in some embodiments the volume fraction of the continuous fiber may not exceed 60%. Alternatively, the nozzle includes a plurality of coaxially aligned distribution channels and/or coaxially aligned channel outlet openings. In these embodiments, the continuous fiber is extruded from the core nozzle opening (first opening), and molten polymeric material is extruded from openings(s) (second opening) disposed around the first opening such that the polymeric material surrounds the continuous fiber. For example, as shown in FIG. 3, the extruder 114 may include a first channel 140 through which the continuous fiber 142 is fed, and a second channel 144 through which the polymeric material 146 is fed. The continuous fiber 142 is extruded from a first nozzle opening 148, and the polymeric material 146 is extruded from a second nozzle opening 150. Since in these embodiments the continuous fiber and polymeric material are fed to separate nozzle channels and extruded from separate nozzle openings, the ratio of continuous fiber to polymeric material (core to coax) can be changed dynamically and may be varied during extrusion in volume fractions ranging between 0% and 60%. Further, the nozzle of the extruder may be included in an end effector 18 that is mounted on a robotic arm 20 (e.g., six-axis robotic arm) for additive manufacturing (3D printing) of the preform on a build plate. One such coaxial extruder end effector is an Orbital S end effector by Orbital Composites, Inc., and other acceptable coaxial extruders are also described in U.S. Pat. No. 10,981,373, the disclosure of which is incorporated herein by reference in its entirety.

Next, the preform is additively manufactured by discharging the molding compound 14 from the nozzle of the extruder 12 onto a deposition surface 16 to produce a three-dimensional preform 22. The deposition surface may include a flat surface such as a build plate or similar to allow formation of the preform prior to transfer to a mold cavity. Also by example, the deposition surface may include a sheet of material (or a shaped substrate) that becomes part of the finished article. Still further optionally, the deposition surface may include a previously manufactured article to be over-molded, such that the preform with continuous fiber serves as an over-molding reinforcement. In yet other embodiments, the deposition surface may include a female die such that the preform is manufactured directly in the die for the compression molding step described below. Deposition of the preform directly into the die can be realized by using multiple extruder tools (e.g., multiple extruder end effectors each of which may be mounted to a separate robotic arm) to deposit multiple materials in different parts of the mold, allowing for improved part optimization.

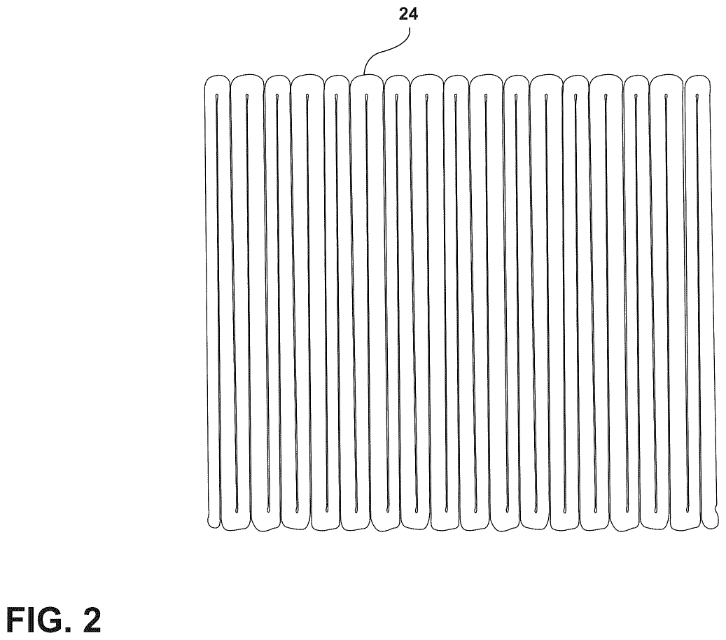

Forming the preform 22 also includes the computer-controlled movement of the extruder relative to the deposition surface 16, such as by articulation of the robotic arm 20 to move the extruder end effector 18 relative to the deposition surface 16. The movement may include synchronized movement of the extruder (or other deposition mechanism), the deposition surface, or both the deposition mechanism and the deposition surface. The movement may also include rotation of the deposition surface on a turntable relative to the extruder. Further, the extrusion may follow a three-dimensional pattern, for example as depicted in FIG. 1, such that the preform 22 includes successive layers of the molding compound 14. In this manner, a first pass of the extruder creates a first extrusion layer and a successive pass of the extruder creates a second extrusion layer above the first extrusion layer, and so on. As shown in FIG. 2, the extrusion can also follow a back-and-forth two-dimensional pattern 24, for example a side-to-side deposition in each extrusion layer of the preform. Thus, the preform may be a single layer or formed of multiple layers (e.g., two, three, four, or more layers). Furthermore, the pattern can be selected such that the preform includes the continuous fiber aligned in a desired orientation, such as but not limited to a unidirectional orientation. However, it should be understood that the continuous fiber placement can be optimized in various orientations or arrangement of unidirectional orientations in different portions of the preform for the desired performance. Thus, in some embodiments the continuous fiber may be arranged omnidirectionally in the preform.

In some embodiments, only one polymeric material and only one continuous fiber material are fed to and discharged from the extruder to manufacture the preform. However, in alternative embodiments more than one continuous fiber material may be combined with one or more polymeric materials, or one or more continuous fiber materials may be combined with more than one polymeric material. For example, two different continuous fiber materials may embedded in two different polymeric materials in the molding compound used to form the preform. Particularly, in certain embodiments, a first polymeric material and a first continuous fiber are fed into the extruder, the first continuous fiber together with the first polymeric material forming a first molding compound, and a second polymeric material different than the first polymeric material and a second continuous fiber different than the first continuous fiber are also fed into the extruder, the second continuous fiber together with the second polymeric material forming a second molding compound. Subsequently, the step of forming a three-dimensional preform includes discharging both the first molding compound and the second molding compound together onto the deposition surface.

Forming the preform 22 generally includes extruding the molding compound 14 in a two or three-dimensional pattern onto the deposition surface 16 as described above. The density of the continuous fiber in the molding compound can be fixed or may be varied, depending on the particular application (e.g., between 0% by volume and 60% by volume continuous fiber, further optionally at least 20% by volume continuous fiber, optionally at least 40% by volume, optionally 60% by volume). In addition, extruded sections of the preform can include a neat polymeric material without any continuous fiber. Further by example, the continuous fiber itself can be varied when forming the preform to provide a multi-material preform having a graded change in material composition. In one example, the method of forming a bulk molding compound may include introducing a second continuous fiber (e.g., glass fiber) in place of the first continuous fiber (e.g., carbon fiber) such that the extruded preform includes a change in material composition along its length. Still other embodiments include transitioning from a molding compound including polymeric material and a continuous fiber to a polymer having no continuous fiber. These transitions can be gradual or abrupt, depending on the desired material properties of the finished article that is obtained from the preform (as described below). Yet other embodiments include a mixture of more than one continuous fiber with more than one polymeric material, which mixture is generally uniform throughout the preform.

Next, the method 10 includes compression molding the additive manufactured preform 22 within a mold 26 to form the finished compression molded article 28. Particularly, a mold charge 30 is formed by positioning the three-dimensional preform 22 within the mold 26 (either by transferring the preform from the deposition surface to the mold, or by directly forming the preform within the mold, i.e. the deposition surface is a surface of the mold). The mold may have a top mold component 32 (that is a male mold part) and a bottom mold component 34 (that is a female mold part). Preferably, the preform 22 is positioned in the bottom mold 34 to form the mold charge 30, and the mold may be by way of example a fast acting compression molding hot-press. The mold charge 30 includes embedded continuous fiber reinforcement, and may include two or more layers of the extrusion (e.g., an upper layer supported by a lower layer) as described above. The mold charge 30 is then compression molded within the mold 26 to produce a rate of flow within the mold cavity, dependent upon the amount of heat and pressure applied during the molding process. The continuous fiber is distributed within the polymeric material such that the finished article 28 formed in the mold has the desired mechanical properties. For example, when the continuous fiber is positioned across joints of a finished article, the continuous fiber enhances the mechanical performance of the joints. Further, the z-direction and y-direction properties of the 3D printed preform substrate and the subsequent finished article obtained by compression molding the preform are enhanced by the continuous fiber disposed in the preform during formation of the preform. Furthermore, the continuous fiber in the preform and subsequent finished article allows for imparting of multi-functionalities into finished articles such as electrical, thermally conductive, and/or insulative functionality depending on the properties (electrical conductivity, thermal conductivity, insulating) of the continuous fiber.

### Example

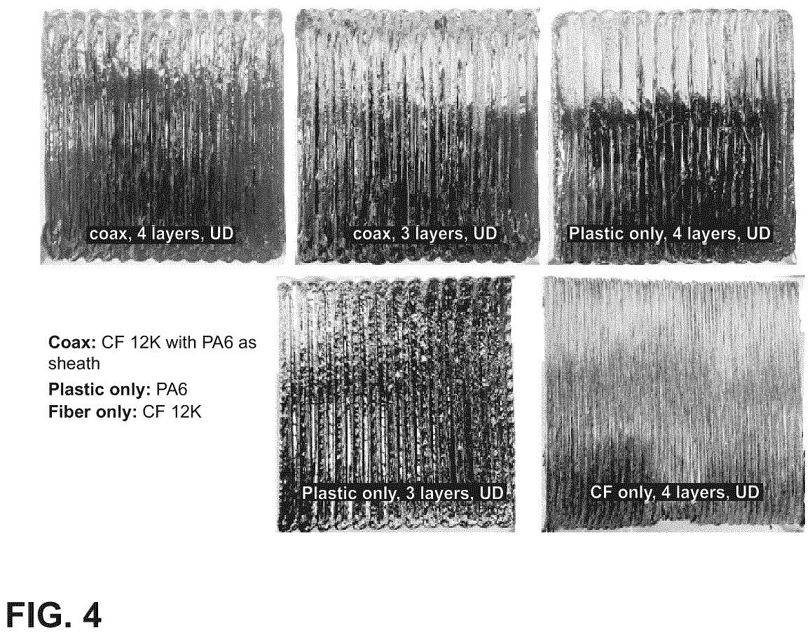

Continuous fiber preforms were additively manufactured as follows. A continuous fiber extruder nozzle with a single central channel was used to melt, extrude, and weld thermoplastic filaments on a build plate. Specifically, continuous comingled fiber (carbon fiber (CF)—Thermofiber 12K CF-PA12; glass fiber (S2)—Thermofiber 12K S2-PA12, and Hybrid (carbon and glass fiber)—Thermofiber 12K CF-PA12+PEEK PA6) embedded in a thermoplastic nylon matrix were 3D printed to obtain composite preform plaques. Also, continuous fiber and polymeric material were coaxially extruded from an Orbital S coaxial extrusion nozzle by Orbital Composites, Inc. to obtain composite preform plaques. Examples of the coaxially extruded preforms are shown in FIG. 4. The 3D printed preforms were compression molded using a hydraulic press (a hot-press: Carver Press-30 Ton). Thermofiber 12K CF-PA12 and Thermofiber 12K S2-PA12 preforms were hot-pressed at 185° C. for 15 minutes while maintaining a pressure of 5 tons. Hybrid Thermofiber 12K CF-PA12+PEEK PA6 preforms were hot-pressed at 225° C. for 15 minutes while maintaining a pressure of 5 tons.

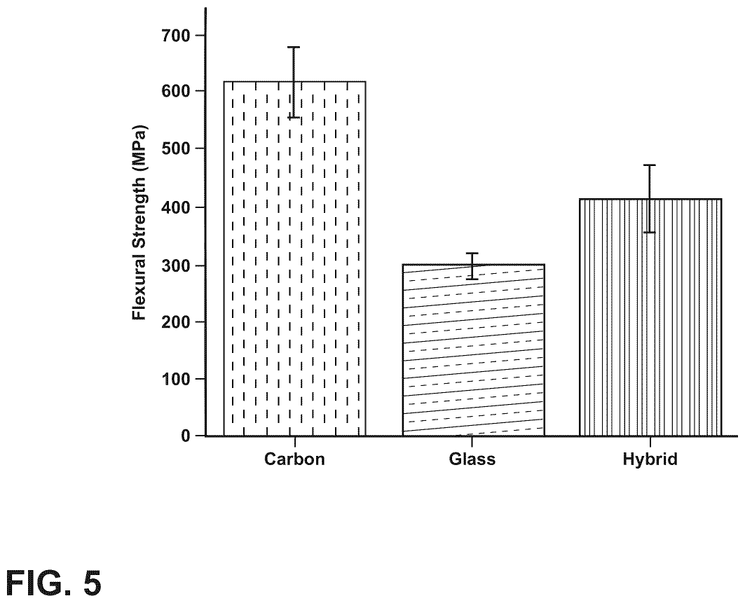

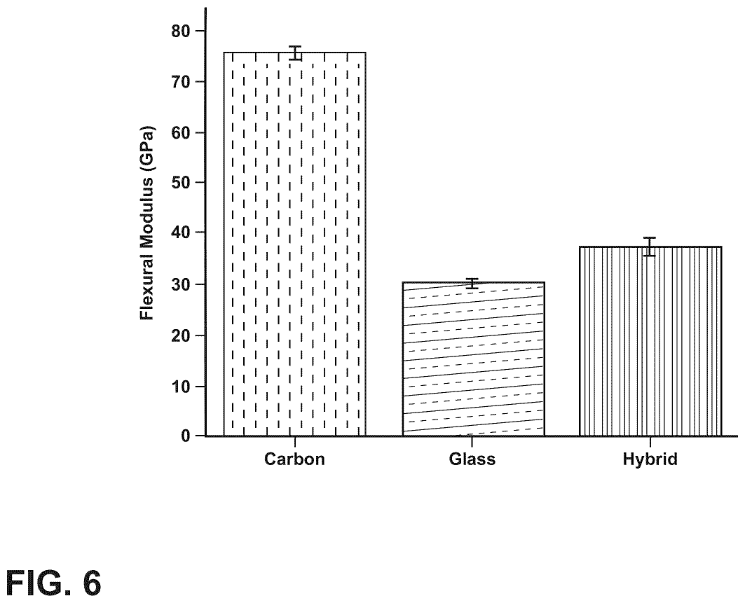

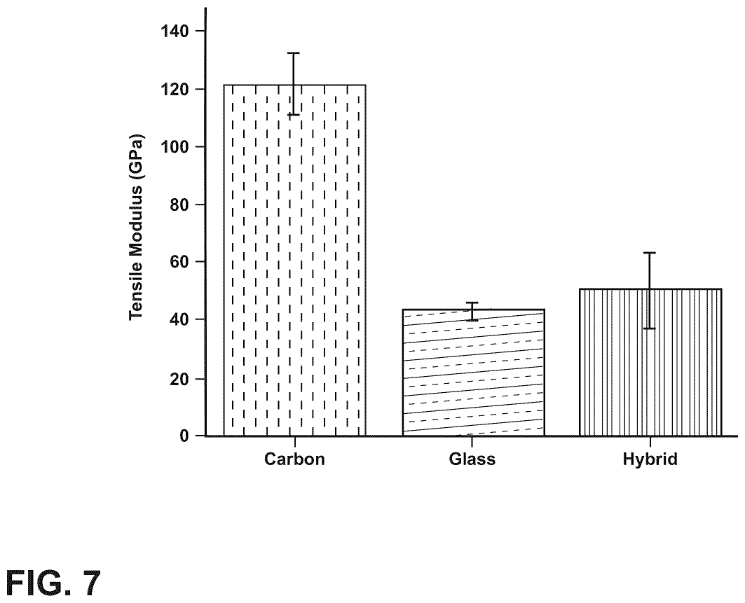

Tensile and flexural properties of the articles obtained by compression molding the additively manufactured preforms were measured according to ASTM D3039 and ASTM D790 standards, respectively. A Test Resources Universal Testing Machine (UTM) equipped with a 50 kN load cell was used for mechanical testing. Flexure and tensile test results are shown in FIGS. 5-7. Flexural strength and flexural modulus of the AM-CM Thermofiber 12K CF-PA12 sample was found to be 615.37 MPa and 75.65 GPa, respectively. The Ultimate tensile strength of carbon fiber composite was not measured as the testing reached the maximum capacity of the Test Resource Frame. Tensile modulus of carbon composite was evaluated to be 122.23 GPa. These numbers are significantly high as compared to any AM-produced continuous carbon fiber (CF) thermoplastic composites. For comparison, CF epoxy composite with 60% by volume CF has a tensile modulus of 135 GPa, which means that the AM-CM method disclosed herein can achieve 91% of the tensile modulus using a more environmentally friendly thermoplastic composite. Similarly, the tensile modulus of glass fiber composite was 43.08 GPa, which is 7.5% higher than an epoxy-based E-glass fiber composite. Further, the mechanical property measurements of the hybrid samples confirmed that an intermediate performance was achieved. Flexural strength and flexural modulus of the AM-CM Hybrid Thermofiber 12K CF-PA12+PEEK PA6 sample were found to be 412.58 MPa and 36.95 GPa. Tensile modulus was measured at 50.08 GPa.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of manufacturing an article, the method comprising:
feeding a polymeric material into an extruder having a nozzle;
feeding a continuous fiber into the extruder, the continuous fiber and the polymeric material together forming a molding compound;
discharging the molding compound from the nozzle onto a deposition surface to form a three-dimensional preform;
forming a mold charge by positioning the three-dimensional preform within a mold, the mold including a top mold component and a bottom mold component; and
compression molding the mold charge within the mold to form a finished article.

2. The method of claim 1, wherein the nozzle of the extruder includes a single central channel configured to discharge the continuous fiber with the polymeric material.

3. The method of claim 2, wherein a volume fraction of the continuous fiber in the polymeric material is greater than 0% and less than or equal to 60%.

4. The method of claim 1, wherein the nozzle of the extruder includes coaxially aligned channels.

5. The method of claim 4, wherein a volume fraction of the continuous fiber in the polymeric material is varied between 0% and 60%.

6. The method of claim 1, wherein the continuous fiber is one of a carbon fiber, a glass fiber, a basalt fiber, and a Kevlar fiber.

7. The method of claim 1, wherein the continuous fiber is arranged unidirectionally in the preform.

8. The method of claim 1, wherein the polymeric material is one of a thermoplastic and a thermoset.

9. The method of claim 8, wherein the polymeric material includes at least one of a nylon material, polyetheretherketone (PEEK), polyaryletherketone (PAEK), polyetherketone (PEK), polyetherketoneketone (PEKK), acrylonitrile butadiene styrene (ABS), polycarbonate (PC), polyphenylene sulfide (PPS), polyethylenimine (PEI), and polypropylene (PP).

10. The method of claim 1, wherein the extruder is a coaxial extruder including coaxial channels, the polymeric material includes a first polymeric material and a second polymeric material, the continuous fiber includes a first continuous fiber and a second continuous fiber, and the steps of feeding a polymeric material and feeding a continuous fiber into the extruder include:
feeding the first polymeric material into the extruder;
feeding the first continuous fiber into the extruder, the first continuous fiber together with the first polymeric material forming a first molding compound;
feeding the second polymeric material into the extruder, the second polymeric material being different than the first polymeric material;
feeding the second continuous fiber into the extruder, the second continuous fiber being different than the first continuous fiber, and the second continuous fiber together with the second polymeric material forming a second molding compound; and
the step of forming a three-dimensional preform includes discharging both the first molding compound and the second molding compound together onto the deposition surface.

11. A compression molded article formed by the method of claim 1.

12. A compression molded article formed by the method of claim 10.

13. A method of forming an additively manufactured preform for compression molding of an article, the method comprising:
feeding a polymeric material into an extruder including a nozzle;
feeding a continuous fiber into the extruder, the continuous fiber and the polymeric material together forming a molding compound; and
forming a three-dimensional preform by discharging the molding compound from the nozzle onto a deposition surface.

14. The method of claim 13, wherein the continuous fiber is embedded in the polymeric material, and the continuous fiber and polymeric material are simultaneously discharged together from a same nozzle of the extruder.

15. The method of claim 13, wherein the extruder is a coaxial extruder including a nozzle having a first opening coaxially aligned with a larger second opening, the continuous fiber is discharged through the first opening, and the polymeric material is discharged through the second opening so as to surround the continuous fiber upon exit from the nozzle.

16. The method of claim 13, wherein the continuous fiber is arranged unidirectionally in the preform.

17. The method of claim 13, wherein the continuous fiber is one of a carbon fiber, a glass fiber, a basalt fiber, and a Kevlar fiber.

18. The method of claim 13, wherein the polymeric material is one of a thermoplastic and a thermoset.

19. The method of claim 13, wherein the polymeric material includes at least one of a nylon material, polyetheretherketone (PEEK), polyaryletherketone (PAEK), polyetherketone (PEK), polyetherketoneketone (PEKK), acrylonitrile butadiene styrene (ABS), polycarbonate (PC), polyphenylene sulfide (PPS), polyethylenimine (PEI), and polypropylene (PP).

20. The method of claim 13, wherein a volume fraction of the continuous fiber in the polymeric material is greater than 0% and less than or equal to 60%.
